(19) United States
(12) Patent Application Publication
(10) Pub. No.: US 2006/0291344 A1
(43) Pub. Date: Dec. 28, 2006

(54) Yoke and objective lens actuator having same

(75) Inventors: Jin-Bo Qiu, Shenzhen (CN); Jing-Wei Su, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/446,922

(22) Filed: Jun. 5, 2006

(30) Foreign Application Priority Data
Jun. 25, 2005 (CN) 200520060697.8

(51) Int. Cl. G11B 7/00

(52) U.S. Cl. 369/44.15

(57) ABSTRACT

An objective lens actuator includes a base, a suspension apparatus mounted on the base, a holder for holding an objective lens, the holder suspended by the suspension apparatus, and a voice coil motor (VCM) driving the holder to vibrate, wherein the VCM includes a pair of yokes, each of the pair of yokes includes a first part and a second part, the first part and the second part are joined in a generally rectangular shape. The objective lens actuator can form an even magnetic field Allowing very precise focusing of a lens.

### BACKGROUND

1. Field of the Invention

The present invention relates to optical pickup apparatuses, and particularly to a yoke which has a uniform magnetic field and an objective lens actuator using the yoke.

2. General Background

Generally, an objective lens actuator of an optical pickup apparatus includes a base, a suspension mounted to the base, a lens holder for holding an objective lens, a Voice Coil Motor (VCM) driving the lens holder, a pair of U-shaped yokes mounted to the base, a pair of permanent magnets respectively mounted to the pair of yokes. When a current flows through the VCM, the VCM vibrates in the magnetic field formed by the pair of permanent magnets. The lens holder driven by the VCM also vibrates to precisely focus a laser light through the objective lens on a correct track so that data may be accurately read from or written to a data storage medium. Thus, preserving capability of precisely focusing on the correct track is a key point in the design of an objective actuator. Equilibrium of the magnetic field is an important issue for maintaining the capability of precisely focusing on the correct track. However, because the yokes are U-shaped, a magnetic flux density of bottom areas within the yokes is greater than that of top areas within the yokes. Thus, the magnetic field within the yokes is not uniform, resulting in less than an optimum result when attempting to focus the lens.

What is needed is to provide yokes in which the magnet can form a uniform magnetic field, and an objective actuator having the same.

### SUMMARY

In one preferred embodiment, an objective lens actuator includes a base, a suspension apparatus mounted on the base, a holder for holding an objective lens, the holder suspended by the suspension apparatus, and a voice coil motor (VCM) driving the holder to vibrate, wherein the VCM includes a pair of yokes, each of the pair of yokes includes a first part and a second part, the first part and the second part are joined in a generally rectangular shape.

Other advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of an objective lens actuator in accordance with a preferred embodiment of the present invention, the objective lens actuator includes an objective lens, magnets, and yokes;

FIG. 2 is an assembled view of the yokes and the magnets of the FIG. 1; and

FIG. 3 is an assembled view of the objective lens actuator of the FIG. 1.

### DETAILED DESCRIPTION OF THE EMBODIMENT

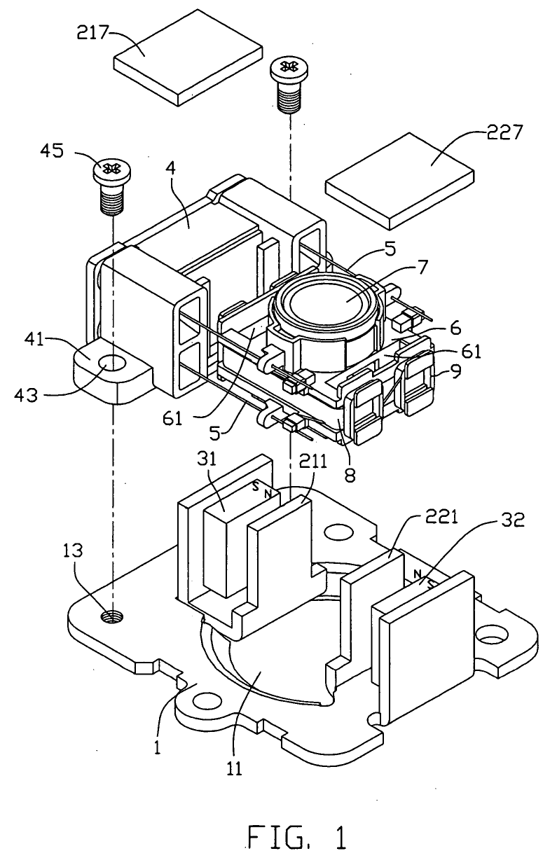

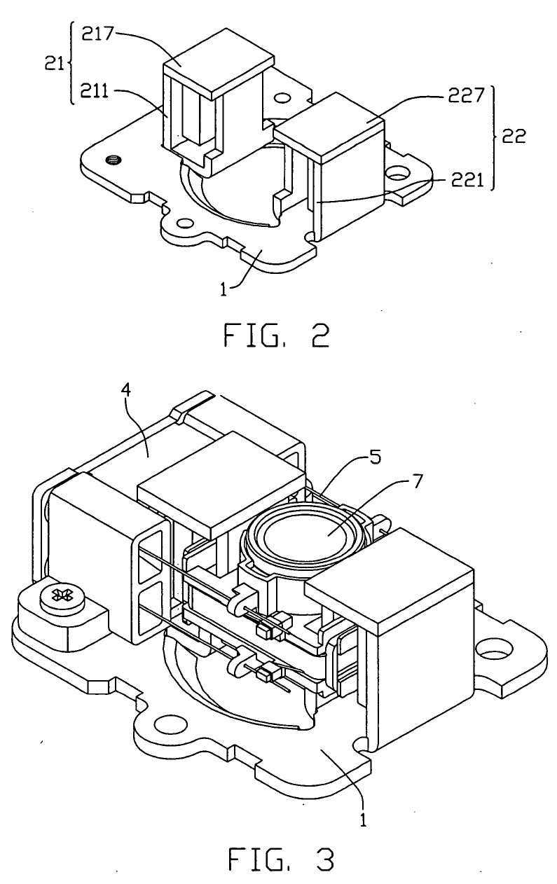

Referring to FIGS. 1 and 2, an objective lens actuator of an optical pickup apparatus in accordance with a preferred embodiment of the present invention includes a base 1, a pair of yokes 21, 22, a pair of magnets 31, 32, a fixture 4, four wires 5 with one end of each wire 5 fixed to the fixture 4, a holder 6 suspended on the other ends of the four wires 5, a focusing coil 8, and four tracking coils 9.

The base 1 defines a loophole 11 in a center thereof, and two threaded holes 13 defined in opposite corners of a same side. Each of the pair of yokes 21 and 22 includes a U-shaped first part 211 and 221, and a second part 217 and 227 consecutively. Each of the first parts 211 and 221 has two branches parallel spaced from each other with one side thereof connected with each other due to the U shape of the first parts 211 and 221. The first parts 211 and 221 are mounted on and protrude up from the base 1 at opposite sides of the loophole 11. The first part 211 is between the threaded holes 13. The magnets 31 and 32 are respectively received in the first parts 211 and 221, and mounted to inner sidewalls of the branches of the first parts 211 and 221 away from the loophole 11. North poles of the magnets 31 and 32 face each other across the loophole 11. The second parts 217 and 227 are plane shaped, and made of materials having magnetic permeability.

The holder 6 defines a circular through hole (not shown in the FIG) thereof for holding an objective lens 7 therein. A pair of slots 61 is defined in the holder 6 for another sidewall of the first part 211 and 221 passing therethrough. The focusing coil 8 encircles around an end of the holder 6, and is electrically connected to the wires 5. Two of the tracking coils 9 are mounted to one side of the holder 6, and the other two of the tracking coils 9 are mounted to the other opposite side of the holder 6. The tracking coils 9 are also electrically connected to the wires 5.

A top surface of the focusing coil 8 is perpendicular to an optical axis of the objective lens 7. The tracking coils 9 are mounted on a same plane parallel to the optical axis of the objective lens 7.

The fixture 4 includes a pair of fixing portions 41 extending from opposite sides thereof. Each fixing portion 41 defines a locking hole 43, corresponding to a threaded hole 13 of the base 1.

Referring to the FIG. 3, in assembly, the locking holes 43 of the fixture 4 align with the threaded holes 13 of the base 1. Screws 45 are inserted through the locking holes 43 to be engaged in the threaded holes 13. The sidewalls of the first parts 211 and 221 adjacent the loophole 11 of the base 1 are respectively received into the slots 61 of the holder 6. The second parts 217 and 227 are respectively fixed to tops of the branches of the first parts 211 and 221 of the yokes 21 and 22. Then the objective lens 7 is suspended above the loophole 11 of the base 11 via the wires 5. Light passes through the loophole 11 to shine on the objective lens 7. Thus, the combined assembly of the fixture 4, the wires 5, the holder 6, the objective lens 7, the focusing coil 8, and the tracking coils 9 is mounted to the base 1. The yokes 21 and 22, the magnets 31 and 32, the focusing coil 8, and the tracking coils 9 cooperatively form a voice coil motor (VCM). The fixture 4 and the wires 5 cooperatively form a suspension apparatus.

When a current flows through the focusing coil 8, a Lorentz force acts on the focusing coil 8 parallel to the optical axis of the objective lens 7. Thus, the focusing coil 8 drives the holder 6 to move along the optical axis of the objective lens 7. When a current flows through the tracking coils 9, a Lorentz force acts on the tracking coils 9 perpendicular to the optical axis of the objective lens 7. Thus, the tracking coils 9 drive the holder 6 to move in a plane perpendicular to the optical axis of the objective lens 7. A moving line of the holder 6 is perpendicular to the optical axis of the objective lens 7.

In the illustrated embodiment, the yokes 21 and 22 are annular due to the second parts 217 and 227 fixed to the tops of the U-shaped first parts of the yokes 21 and 22. The U-shaped first parts 211 and 221, each have a greater magnetic flux density at a bottom area than that of a top area within the first parts 211 and 221. However, the yokes 21 and 22 have a great magnetic permeability in the top area because of the second parts 217 and 227, the magnetic flux density of the overall magnetic field for the yokes 21 and 22 is uniform. According to the Lorentz Law, a Lorentz force is directly proportional to a magnetic flux density of a magnetic field. If the magnetic flux density is uniform overall, then the Lorentz force will act evenly over the magnet field. An even uniform Lorentz force provides greater precision in focusing the objective lens 7.

It is believed that the present embodiments and its advantages will be understood from the foregoing description, and it will be apparent that various changes may be made thereto without departing from the spirit and scope of the invention or sacrificing all of their material advantages, the examples hereinbefore described merely being preferred or exemplary embodiments of the invention.

We claim:

1. An objective lens actuator comprising:
a base;
a suspension apparatus mounted on the base;
a holder for holding an objective lens, the holder suspended by the suspension apparatus; and
a voice coil motor (VCM) driving the holder to vibrate, wherein the VCM comprises a pair of yokes, each of the pair of yokes comprises a first part and a second part, the first part and the second part are joined to form a rectangular-loop shape.

2. The objective lens actuator as claimed in claim 1, wherein the first parts of the pair of yokes are U-shaped, the second parts of the pair of yokes are plane shaped, the second parts are respectively mounted on tops of the first parts for jointing the first part and the second part.

3. The objective lens actuator as claimed in claim 2, wherein the second parts of the pair of yokes are made of materials having magnetic permeability.

4. The objective lens actuator as claimed in claim 3, wherein the VCM further comprises a pair of magnets received in the yokes, a focusing coil encircles the holder, a plurality of tracking coils respectively mounted to two opposite sides of the holder, and the focusing coil and the tracking coils are electrically connected to the wires.

5. The objective lens actuator as claimed in claim 1, wherein the suspension apparatus comprises a fixture and four wires, the fixture is mounted on the base, one end of each of the four wires is fixed to the fixture, the other end of each of the four wires is fixed to the holder.

6. The objective lens actuator as claimed in claim 1, wherein the base defines a loophole in a center thereof for a light passing through.

7. A yoke for an objective lens actuator, the yoke comprising:
a first part for fixing a magnet; and
a second part; wherein the first part and the second part are mechanically joined to form a complete loop magnetic-permeable area in the yoke.

8. The yoke as claimed in claim 7, wherein the first part is U-shaped.

9. The yoke as claimed in claim 7, wherein the second part is plane shaped for jointing across an open defined by distal ends of a U-shaped portion of the yoke, and the second part is made of materials having magnetic permeability.

10. The yoke as claimed in claim 7, wherein the complete loop magnetic-permeable area in the yoke is rectangular-loop shaped.

11. An optical apparatus comprising:
parts of said optical apparatus installable in said optical apparatus for performing image-pickup function of said optical apparatus;
an objective lens installable in said optical apparatus next to said parts, and light passing through said objective lens to reach said parts of said optical apparatus for treatment by said parts; and
an actuator installable beside said objective lens to adjustably control a relative location of said objective lens in said optical apparatus, said actuator comprising a voice coil motor (VCM) having a U-shaped yoke contributing to generation of a magnetic field in said VCM, said yoke comprising two branches spaced from each other with a first side of each of said two branches integrally connectable with each other and a second side of said each of said two branches opposite to said first side discrete from each other, means for increasing magnetic permeability along said second side of said each of said two branches installable in said yoke beside said two branches.

12. The optical apparatus as claimed in claim 11, wherein said means is a part made of materials having magnetic permeability and placed along said second side of said each of said two branches to mechanically join said two branches along said second side.
